(19) United States
(12) Patent Application Publication
(10) Pub. No.: US 2022/0122118 A1
(43) Pub. Date: Apr. 21, 2022

(54) PLANNING DEVICE AND COMPUTER PROGRAM

(71) Applicant: HAKUHODO DY HOLDINGS INC., Tokyo (JP)

(72) Inventors: Ryo DOMOTO, Tokyo (JP); Ryoji MINAMI, Tokyo (JP)

(21) Appl. No.: 17/442,691

(22) PCT Filed: Mar. 26, 2020
(86) PCT No.: PCT/JP2020/013683

§ 371 Date: Sep. 24, 2021

(30) Foreign Application Priority Data
Mar. 27, 2019 (JP) 2019-061274

(51) Int. Cl. G06Q 30/02; G06N 20/00

(52) U.S. Cl. CPC G06Q 30/0242; G06Q 30/0251; G06N 20/00; G06Q 30/0249; G06Q 30/0272

(57) ABSTRACT

An event plan acquirer is configured to acquire event planning information which is planning information on an external event in a future target period. The external event is an event of which implementation is plannable in advance, of which implementation or notification of the implementation may affect results of programmatic advertising, and which is different from programmatic advertising delivery. A target condition acquirer is configured to acquire target condition information indicating a target condition related to results in a target period of the programmatic advertising. A planner predicts the results of the programmatic advertising in the target period based on the event planning information, the programmatic advertising delivery plan in the target period, and a prescribed prediction model, and creates the programmatic advertising delivery plan in the target period so that the predicted results approach results indicated in the target condition information.

### CROSS-REFERENCE TO RELATED APPLICATION

This international application claims priority based on Japanese Patent Application No. 2019-061274 filed on Mar. 27, 2019 with the Japan Patent Office, and the entire disclosure of Japanese Patent Application No. 2019-061274 is incorporated in the present international application by reference.

### TECHNICAL FIELD

The present disclosure relates to a planning device for creating a programmatic advertising delivery plan and a computer program for causing a computer to function as the planning device.

### BACKGROUND ART

Patent Document 1 discloses a system for optimizing a delivery plan of contents such as television, radio, and websites. This system acquires optimization information for generating an optimized schedule, such as history measurement information like audience rating, and advertising inventory information. This system predicts impressions based on the acquired optimization information, and optimizes a delivery schedule of the contents based on the predicted impressions.

### PRIOR ART DOCUMENTS

### Patent Documents

Patent Document 1: Japanese Unexamined Patent Application Publication (Translation of PCT Application) No. 2017-527874

### SUMMARY OF THE INVENTION

### Problems to be Solved by the Invention

It is conceivable to create a delivery plan of programmatic advertising such as search advertising and banner advertising so that targeted results are achieved. Search advertising is also called listing advertising. Targeted results include, for example, KPIs such as targeted impressions and reach rate. KPI is an abbreviation for Key Performance Indicator. Other than various conditions included in the delivery plan of programmatic advertising, various factors may affect results of programmatic advertising. Thus, in creating a programmatic advertising delivery plan in a future target period, it is desirable to consider influences of external factors which may occur in the target period.

One aspect of the present disclosure is to consider the influences of the external factors which may occur in the future target period, thereby improving estimation accuracy of the programmatic advertising delivery plan to achieve the targeted results.

### Means for Solving the Problems

One embodiment of the present disclosure provides a planning device for creating a programmatic advertising delivery plan related to a target advertising campaign. The planning device comprises an event plan acquirer, a target condition acquirer, and a planner. The event plan acquirer is configured to acquire event planning information. The event planning information is planning information on an external event in a future target period. The external event is an event of which implementation is plannable in advance, of which implementation or notification of the implementation may affect results of programmatic advertising, and which is different from programmatic advertising delivery. The target condition acquirer is configured to acquire target condition information. The target condition information indicates a target condition related to results of the programmatic advertising in the target period. The planner predicts the results of the programmatic advertising in the target period based on the event planning information, the programmatic advertising delivery plan in the target period, and a prescribed prediction model. The planner creates the programmatic advertising delivery plan in the target period so that the predicted results approach results indicated in the target condition information. The prediction model is a model for predicting the results of the programmatic advertising based on the event planning information and the programmatic advertising delivery plan.

With the configuration as such, the planning device creates the programmatic advertising delivery plan in the target period based on the event planning information in the future target period. Accordingly, by considering the influence of the external event as an external factor in the target period, it is possible to improve estimation accuracy of the programmatic advertising delivery plan to achieve the targeted results.

The prediction model is a model that is built so as to predict the results of the programmatic advertising including the influence of the external event that is planned by the event planning information.

In one embodiment of the present disclosure, the event planning information may include at least one of: information on a reserved advertising delivery plan; planning information on a press release for goods or services related to the advertising campaign; planning information on an exhibition for the goods or services; and information indicating a broadcast schedule or a delivery schedule of a program of a contents output device that outputs contents.

With the configuration as such, by considering the information on the reserved advertising delivery plan, etc., it is possible to improve estimation accuracy of the programmatic advertising delivery plan to achieve the targeted results.

In one embodiment of the present disclosure, the planning device may further comprise a programmatic planning acquirer. The programmatic planning acquirer is configured to acquire the programmatic advertising delivery plan in the target period. The prediction model may comprise a first prediction model and a second prediction model. The first prediction model is a model that enables prediction of results of the external event based on the event planning information. The second prediction model is a model that enables prediction of the results of the programmatic advertising based on the results of the external event and the programmatic advertising delivery plan. The planner may comprise a first predictor, a second predictor, and a planning processor. The first predictor is configured to use the first prediction model to predict the results of the external event in the target period based on the event planning information. The second predictor is configured to use the second prediction model to predict the results of the programmatic advertising in the target period based on the results of the external event in the target period predicted by the first predictor and the programmatic advertising delivery plan in the target period. The planning processor is configured to change the programmatic advertising delivery plan in the target period so that the results of the programmatic advertising in the target period predicted by the second predictor approach the results indicated in the target condition information.

With the configuration as such, for example, as compared with a configuration in which the results of the programmatic advertising in the target period are predicted without predicting the results of the external event in the target period from the event planning information, it is possible to increase estimation accuracy of programmatic planning information to achieve the targeted results.

In one embodiment of the present disclosure, the planning device may further comprise a budget acquirer. The budget acquirer is configured to acquire information on a budget amount related to programmatic advertising delivery in the target period. The planner may create the programmatic advertising delivery plan in the target period based on the budget amount.

With the configuration as such, the programmatic advertising delivery plan can be created to approach the targeted results while satisfying the budget amount.

In one embodiment of the present disclosure, the planner may create the programmatic advertising delivery plan such that a total programmatic advertising cost in an entire campaign period of the advertising campaign is the budget amount at an end of the campaign period. The phrase “is the budget amount” herein does not have to mean that the total advertising cost exactly matches the budget amount. As long as the desired effect is achieved, the total advertising cost may be slightly different from the budget amount. The same applies hereinafter.

With the configuration as such, loss of opportunities such as for conversion can be reduced.

In one embodiment of the present disclosure, information on the budget amount may include information on a budget amount in each of multiple periods obtained by dividing the target period. The planner may create the delivery plan such that programmatic advertising costs in each of the multiple periods are the budget amount in the corresponding period.

With the configuration as such, loss of opportunities such as for conversion can be reduced.

In one embodiment of the present disclosure, the planner may create the delivery plan such that programmatic advertising costs in a first period are greater or smaller than programmatic advertising costs in a second period. Here, the first period is a portion of the target period during which the external event is implemented or the results of the external event are equal to or greater than a first threshold. The second period is a portion of the target period during which the external event is not implemented or the results of the external event are equal to or smaller than a second threshold. The second threshold is equal to or smaller than the first threshold.

With the configuration as such, the results of the programmatic advertising such as impressions can be increased.

In one embodiment of the present disclosure, the planning device may further comprise a learner. The learner is configured to use learning data to learn the prediction model. The learning data includes the past event planning information, the past programmatic advertising delivery plan, and the past results of the programmatic advertising.

With the configuration as such, prediction accuracy of the prediction model can be improved by learning. As a result, the delivery plan most suitable for the programmatic advertising is created based on the prediction, and the results of the programmatic advertising can be improved.

In one embodiment of the present disclosure, the planning device may further comprise a filter. The filter is configured to execute a filtering process. The filtering process is a process to extract the event planning information which may affect results of specific programmatic advertising from the event planning information acquired by the event plan acquirer.

With the configuration as such, the event planning information extracted by the filtering process is used to build and update the prediction model. As a result, a calculation amount of the prediction model is reduced and prediction accuracy can be improved.

In one embodiment of the present disclosure, the planning device may further comprise a difference detector. The difference detector is configured to execute a difference detection process on the event planning information acquired by the event plan acquirer. The difference detection process is a process to detect a difference between the event planning information acquired by the event plan acquirer and the already acquired event planning information.

With the configuration as such, as compared with a case where all the event planning information including the event planning information already required is used to update the prediction model, time to update the prediction model can be reduced. The difference is, in other words, an update from the already acquired event planning information.

Another aspect of the present disclosure may provide a computer program that causes a computer to function as the planning device. With the configuration as such, the same effects as those in the above-described planning device can be achieved.

### BRIEF DESCRIPTION OF THE DRAWINGS

FIG. 1 is a diagram showing a configuration of a planning system.

FIG. 2 is a block diagram showing a configuration of an agency server.

FIG. 3 is a block diagram showing a configuration of a planning server.

FIG. 4 is a flowchart of a planning process of a first embodiment.

FIG. 5 is a diagram (1) illustrating a process to create a programmatic advertising delivery plan.

FIG. 6 is a diagram (2) illustrating the process to create the programmatic advertising delivery plan.

FIG. 7 is a diagram (3) illustrating the process to create the programmatic advertising delivery plan.

FIG. 8 is a diagram (4) illustrating the process to create the programmatic advertising delivery plan.

FIG. 9 is a flowchart of a planning process of a second embodiment.

### EXPLANATION OF REFERENCE NUMERALS

1 . . . planning system, 11 . . . agency server, 12 . . . advertisement determiner, 13 . . . planning server, 131 . . . communicator, 132 . . . storage, 133 . . . controller.

### MODE FOR CARRYING OUT THE INVENTION

Modes for implementing the present disclosure will be described below with reference to the drawings.

### 1. First Embodiment

### 1-1. Configuration

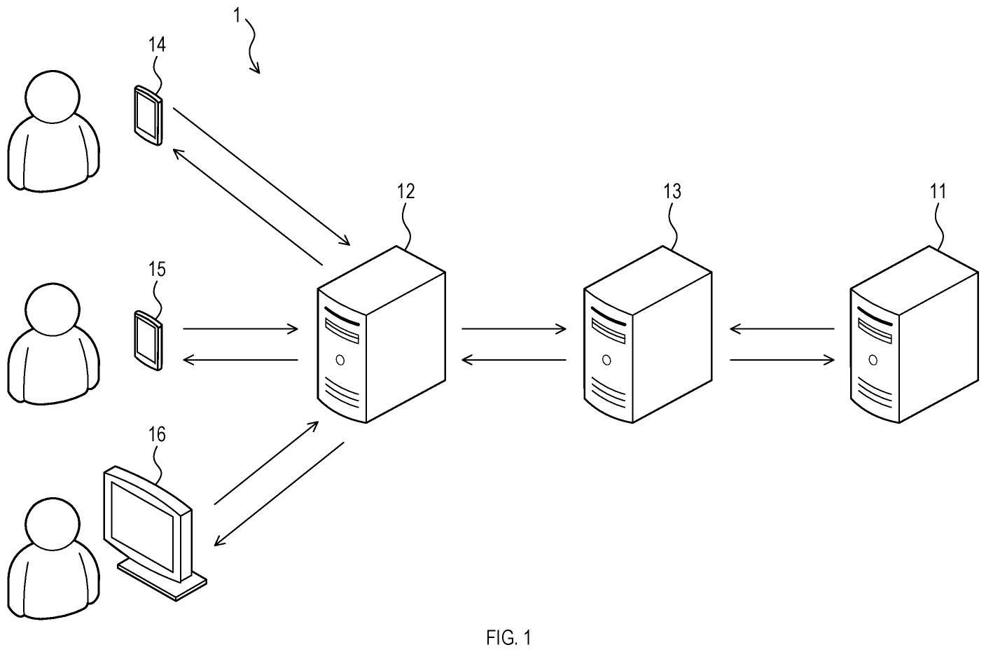

A planning system 1 shown in FIG. 1 is a system for optimizing a programmatic advertising delivery plan so that the programmatic advertising has maximum results.

Specifically, for example, results of the programmatic advertising targeting certain goods or services vary, depending on such as whether a television commercial or the like related to the goods or services is delivered around the same time. In detail, at the time when the related television commercial or the like is delivered, there is an increase in number of keyword searches on the Internet related to the goods or services. It is also predicted that the results of the programmatic advertising such as advertising inventory (i.e., impressions) will increase. The planning system 1 is a system for creating a programmatic advertising delivery plan so as to maximize the results of the programmatic advertising while considering the influence of a later-described external event such as delivery of a television commercial.

The planning system 1 comprises an agency server 11, an advertisement determiner 12, a planning server 13, and user terminals 14 to 16.

<Agency Server 11>

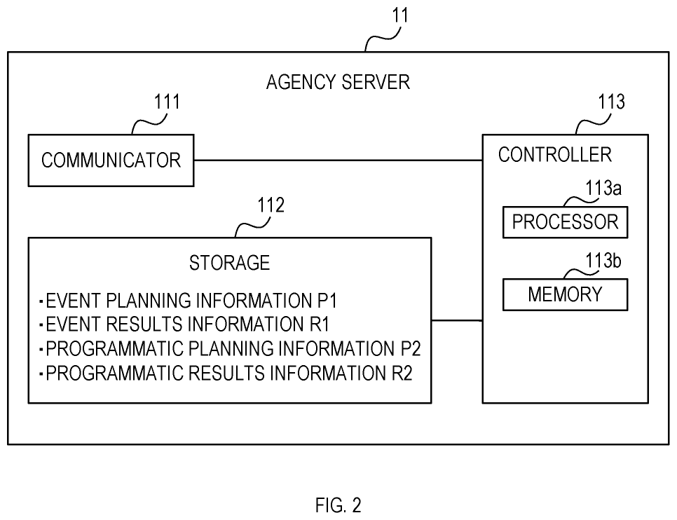

The agency server 11 is used, for example, by an advertising agency. The agency server 11 manages advertising information and the like from advertisers. As shown in FIG. 2, the agency server 11 comprises a communicator 111, a storage 112, and a controller 113.

The communicator 111 is a communication interface for coupling the agency server 11 to a network like the Internet. The agency server 11 communicates data with an external device by wire or wirelessly via the communicator 111. Examples of the external device include the planning server 13, and terminal devices of advertisers (not shown).

The storage 112 stores various information. The storage 112, for example, is configured by a hard disk drive. In the present embodiment, the storage 112 stores event planning information P1, event results information R1, programmatic planning information P2, and programmatic results information R2. In the storage 112, the information P1, R1, P2, and R2 are stored in association with each of advertising campaigns notified by advertisers. Advertising campaigns in the present embodiment include advertising campaigns associated with various advertisements including common products or services. An advertiser can have several campaigns running at the same time.

(Event planning information P1)

The event planning information P1 is planning information on an external event.

The external event herein is an event of which implementation is plannable in advance, of which implementation or notification of the implementation may affect the results of the programmatic advertising, and which is different from programmatic advertising delivery. The external event in the present embodiment includes, for example, an event which affects marketing of goods or services of an advertiser, which is plannable in advance, and further a plan for implementation of which is difficult to be changed. Also, the external event includes, for example, an event that can prompt a user to search keywords for goods, services or brands related to the advertising campaign on the Internet when the event is implemented.

For example, the external event includes reserved advertising delivery. Reserved advertising is an advertisement with preset fee, period, and advertisement placement detail (e.g., posting page, delivery amount, posting detail, etc.) In reserved advertising, it is more difficult to change plans than in programmatic advertising. Typical examples of reserved advertising include advertisements of four traditional mass media, i.e., television commercial, radio commercial, newspaper advertisement and magazine advertisement, outdoor advertisement, and transportation advertisement. Also, reserved advertising include Internet advertisement other than programmatic advertising.

Also, for example, the external event includes a press release of goods or services of an advertiser, and exhibit of the goods or services at an exhibition. Also, for example, the external event includes broadcasting a program of a contents output device such as a television or radio by ground wave or the like, or delivery of the program through Internet communication or the like. In such external events, the pre-planned implementation period is approximately the same as the actual implementation period. However, there may be a slight discrepancy between the pre-planned implementation period and the actual implementation period.

Among the implementations of the external events, delivery of television commercials and radio commercials is conducted by broadcasting stations. Also, among the implementations of the external events, publishing of newspaper advertisement and magazine advertisement is conducted by publishers. Thus, advertisers indirectly contribute to these implementations of the reserved advertising.

On the other hand, among the implementations of the external events, advertisers directly contribute to a press release and exhibit at an exhibition. In other words, the external event in the present embodiment includes an event in which an advertiser directly or indirectly contributes to the implementation and which is related to an advertising campaign. An event related to an advertising campaign is, in other words, an event that forms part of advertising activities related to the advertising campaign.

The event planning information P1 is planning information on an external event. The event planning information P1 includes information on a reserved advertising delivery plan, planning information on a press release for goods or services related to an advertising campaign, and planning information on an exhibition for the goods or services.

The event planning information P1 also includes information indicating a content schedule. The content schedule means a broadcast schedule of a program of a contents output device such as a television or radio by ground wave, etc. or a delivery schedule of the program through Internet communication, etc. In other words, the event planning information P1 includes future information that may affect marketing of the advertiser, that cannot be controlled by the advertiser alone, and that the user can know in advance.

For example, the content schedule may include a broadcast delivery schedule of a program featuring Egypt for a travel agency as an advertiser, a broadcast delivery schedule of World Cup programs for a soccer equipment manufacturer as an advertiser, and so on. Here, the travel agency as an advertiser may not directly or indirectly contribute to the broadcasting or delivery of the program featuring Egypt. Similarly, the soccer equipment manufacturer as an advertiser may not directly or indirectly contribute to the broadcasting or delivery of the World Cup programs. In other words, the external event in the present embodiment includes such events that advertisers do not directly or indirectly contribute to the implementations of the events.

The event planning information P1 may include information such as event target, event frame type, event material, event period and time point, and so on.

The event target indicates an advertisement target such as brands, goods or services to be advertised, in case of reserved advertising. Also, in case of a press release or exhibit at an exhibition, the event target represents goods, services or the like to be released in a press release or exhibited at an exhibition. Also, in case of the content schedule, the event target indicates a program detail, etc.

The external event in the present embodiment includes artificial events implemented by humans. The artificial external events do not include weather events such as sunny, rain, snow, etc. and natural events like natural disasters such as earthquake, tsunami, eruption, etc. Thus, for example, prediction information on natural events like weather forecasts is not included in the event planning information P1 on an artificial external event.

The event frame type indicates an advertisement frame type including, in case of the reserved advertising, medium type, posting medium, posting page, posting position, and so on. In case of a press release and content broadcasting or delivery, the event frame type indicates the medium type, posting medium, posting page, posting position, etc. In case of an exhibition, the event frame type indicates at which exhibition the goods or services are exhibited, etc.

The event material indicates an advertisement material including, in case of the reserved advertising, the size (e.g., magnitude or time length), format (e.g., letter, image or video, presence or absence of color, and so on), story, cast, etc. of the advertisement. In case of a press release and content broadcasting or delivery, the event material indicates the size (e.g., time length), format, story, cast, etc. of the press release or program. In case of an exhibition, the event material indicates exhibition detail, etc.

The event period and time point, in case of reserved advertising, indicates a period and time point when the advertisement is placed. In case of a press release, the event period and time point indicates a period and time point when the press release is made. In case of the content schedule, the event period and time point indicates a period and time point when the program is broadcasted. In case of an exhibition, the event period and time point indicates a period during which the exhibition is held.

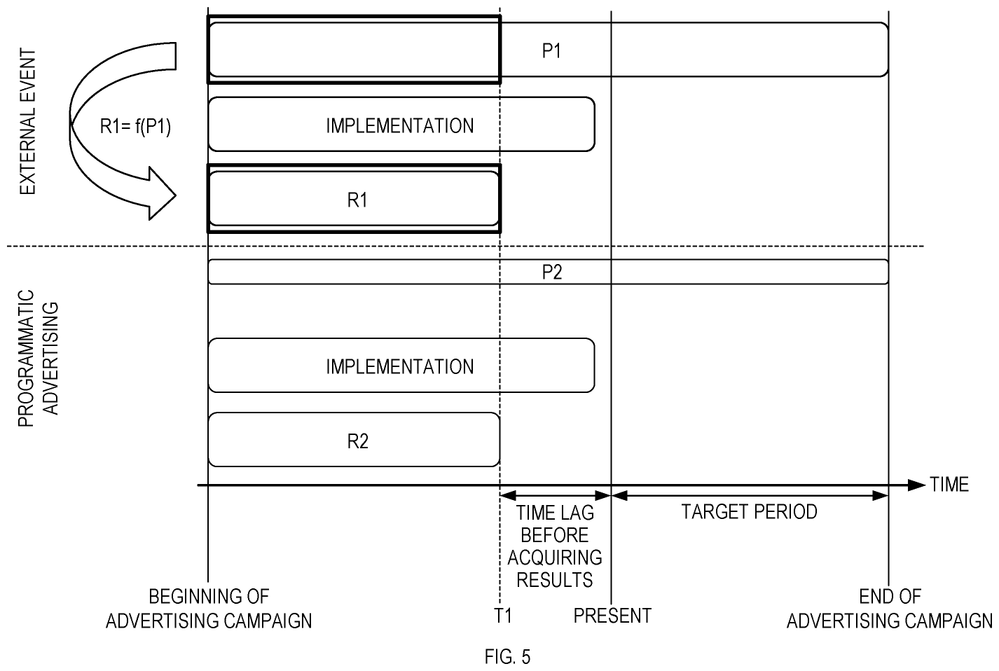

The storage 112, as shown in FIG. 5, stores the event planning information P1 for the entire period from beginning to end of a campaign period of an advertising campaign. Specifically, if the present is in the middle of the campaign period, the storage 112 stores both the past event planning information P1 and the future event planning information P1.

(Event Results Information R1)

The event results information R1 indicates results by implementation (in other words, effect by implementation) of an external event. The event performance information R1 includes metric values of various metrics representing results by the implementation of the external event.

For example, the event results information R1 includes information such as number of exposures, distribution and statistic of number of contacts, number of people reached, reach rate, metric value of behavior change metrics, etc. related to an external event for each segment classified based on user attribute information. Examples of user attribute information herein include demographic attribute information, psychographic attribute information, and geographic attribute information.

The number of exposures (in other words, total number of contacts) is an amount representing cumulatively how many survey panels among the whole survey panels of a segment have come into contact with certain reserved advertising or the like. The “reserved advertising or the like” herein means reserved advertising, press release, exhibition, content schedule or the like.

The same applies hereinafter. Also, the total number of contacts represents how frequently the survey panels have come into contact with the certain reserved advertising or the like.

In case of a television commercial and a radio commercial, examples of metrics representing the total number of contacts include GRP (Gross Rating Point). Also, in case of newspaper advertisement and magazine advertisement, examples of the number of exposures include how many or what percentage of survey panels, among the whole survey panels of a segment, have browsed the advertisement, how many times the survey panels have browsed the advertisement, and so on. Also, in case of a website press release, examples of the number of exposures include how many or what percentage of survey panels, among the whole survey panels of a segment, have browsed the website, how many times the survey panels have browsed the website, and so on. Also, in case of exhibit at an exhibition, examples include how many or what percentage of the survey panels, among the whole survey panels of a segment, have visited the exhibition, how many times the survey panels have visited the exhibition, and so on.

The distribution and statistic of the number of contacts include, for example, how many or what percentage of people, among the whole survey panels of a segment, have contacted certain reserved advertising, etc. As above, the event performance information R1 includes contact performance which is a track record of the survey panels that have contacted a reserved event.

The number of people reached and reach rate represent how many or what percentage of people, among the whole survey panels of a segment, have come into contact with certain reserved advertising or the like not less than n times.

The number of exposures, distribution and statistic of the number of contacts, and the number of people reached and reach rate can be measured, for example, by acquiring viewing data from survey panels, and by conducting a questionnaire to survey panels. Examples of the questionnaire in the present embodiment include street questionnaire, email questionnaire and web page questionnaire conducted via a network. The total number of contacts and the number of contacts with exhibit at an exhibition can be measured using location information of mobile terminals of the survey panels. Also, for example, the number of exposures, distribution and statistic of the number of contacts, and the number of people reached and reach rate may be measured by analyzing log data, using such as television receiver data and data management platform (DMP) as a measurement method other than sampling like survey panels. However, in many cases, with the log data as such, attribute information of contact persons such as survey panels can be acquired only by estimation. Thus, in order to estimate the number of exposures per segment, the log data and survey panel data may be used in combination.

Examples of the behavior change metrics include advertisement recognition rate, brand awareness rate, brand comprehension rate, and purchase intention. The metric value of the behavior change metrics can be acquired by conducting a questionnaire to survey panels.

The event results information R1 may include, other than the number of exposures and the like described above, for example, the number of keyword searches for goods, services, etc. related to certain reserved advertising or the like, inward traffic to the advertiser's website, number of requests for materials related to the advertised goods or services, and so on. Further, the event results information R1 may include various variables such as number of times of installations of application software related to the advertised goods or services, number of starts of the application software, number of times of customer transfers to the advertiser's store, and purchase volume of goods or services.

The storage 112 stores, as shown in FIG. 5, the event results information R1 from beginning of a campaign period to a past certain time point T1. In other words, there is a time lag (i.e., a period between T1 and the present) before the event results information R1 is acquired.

(Programmatic Planning Information P2)

The programmatic planning information P2 is delivery planning information on programmatic advertising related to an advertising campaign. Programmatic advertising is an advertisement in which a specific advertisement frame is not purchased in a fixed manner, and an advertisement placement method is optimized while a posting destination and a bid price are fluctuated. Examples of the programmatic advertising include banner advertising, video advertising on the Internet, and SNS advertising posted along with a social networking service (SNS), in addition to search advertising. Programmatic advertising delivery plan as above can be changed at any time.

The programmatic planning information P2 may include information such as advertisement target, advertisement frame type, advertisement material, bid condition, delivery ON/OFF, delivery pace, bid price, daily budget, and target condition.

The advertisement frame type includes medium type, posting medium, posting page, posting position, etc. The medium type represents, for example, whether the advertisement is search advertising or SNS advertising. The posting medium represents, for example, in case that the medium type is the SNS advertising, whether the SNS advertising is through the SNS of Company A or of Company B. The posting page represents, for example, whether the advertisement is posted on the front page or on the news page of a website.

The advertisement material includes the size (e.g., magnitude or time length), format (e.g., letter, image or video, presence or absence of color), story, cast, etc.

The bid condition indicates bid detail. The bid detail includes search keywords for bid target, bid price, and information that specifies advertisement detail (e.g., text, URL, banner, and so on). Also, the bid condition may include a condition to specify whether or not to display the advertisement to a user having specified user attribute information. User attribute information herein includes demographic attribute information, psychographic attribute information, geographic attribute information, and so on.

The delivery ON/OFF is used to specify whether or not to deliver the programmatic advertising at a specified timing.

The delivery pace is used to specify pacing of budget use for programmatic advertising delivery. The delivery pace includes “standard” or “accelerated” setting. “Standard” is a setting for allocating the budget as evenly as possible throughout the day. “Accelerated” is a setting for allocating a lot of the budget to early hours in order to consume the budget more intensively.

The daily budget represents a value set as an upper limit of daily programmatic advertising costs. The daily budget can be set on a daily basis. In other words, specifying the daily budget makes it possible to specify a schedule for budget consumption during a campaign period of an advertising campaign.

The target condition indicates a condition related to targeted results of the programmatic advertising during a campaign period of an advertising campaign. For example, the target condition may indicate a target value for a KPI. KPI is a quantitative metric to measure a degree of target achievement. Examples of the KPI include click-through count, conversion, etc. Also, the target condition may be a condition such as to maximize a KPI during a target period, without specifically defining a target value for the KPI.

The storage 112, as shown in FIG. 5, stores the programmatic planning information P2 throughout a period from beginning to end of the campaign period. During the campaign period as well, the future programmatic planning information P2 can be changed at any time.

(Programmatic Results Information R2)

The programmatic results information R2 indicates results by programmatic advertising delivery.

For example, the programmatic results information R2 includes the number of exposures (in other words, total number of contacts) of programmatic advertising, number of people reached, distribution and statistic of number of reaches, click-through count of the programmatic advertising, click-through rate, number of conversions, conversion rate, consumption amount, metric value of the behavior change metrics, etc., per operational unit and operating period. The number of exposures indicates advertising inventory (i.e., impressions). The number of people reached indicates the number of browsers, number of devices, number of IDs, etc. that have reached certain programmatic advertising. A budget consumption amount indicates a budget amount consumed (i.e., advertising costs incurred) for a prescribed period (e.g., one hour). The advertising costs herein, for example, incur by pay-per-click.

The programmatic results information R2 can be measured by collecting browsing history of websites from survey panels, or by conducting a questionnaire to survey panels.

Among the items included in the programmatic results information R2, the number of exposures (in other words, total number of contacts), the number of people reached, distribution and statistic of the number of reaches and the metric value of the behavior change metrics are cross-cutting metrics commonly included in the event performance information R1 of reserved advertising.

The storage 112 stores, as shown in FIG. 5, the programmatic results information R2 from the beginning of the campaign period to the past certain time point T1. In other words, there is a time lag (i.e., a period between T1 and the present) before the programmatic results information R2 is acquired.

The controller 113 of the agency server 11 shown in FIG. 2 supervises and controls each part of the agency server 11. The controller 113 is mainly configured by a known microcomputer that comprises a processor 113a such as a CPU (Central Processing Unit) and a GPU (Graphics Processing Unit), and a semiconductor memory (hereinafter, memory 113b) such as a RAM, a ROM, and a flash memory.

<Advertisement Determiner 12>

The advertisement determiner 12 shown in FIG. 1 is a server device to determine an advertisement to be delivered in response to an advertisement delivery request transmitted from the user terminals 14 to 16. The advertisement determiner 12 is a server having a function as a so-called SSP (Supply-Side Platform). The advertisement determiner 12 holds an auction in response to the advertisement delivery request. The advertisement determiner 12 determines an advertisement with the highest bid price as the advertisement to be delivered in response to the request.

<Planning Server 13>

The planning server 13 is a server device having a function as a so-called DSP (Demand-Side Platform). The planning server 13 selects an advertisement to bid at an auction held in response to the advertisement delivery request. The planning server 13 transmits a bid price of the selected advertisement to the advertisement determiner 12. Although not shown in FIG. 1, generally, a plurality of planning servers 13 participate in the auction held by the advertisement determiner 12.

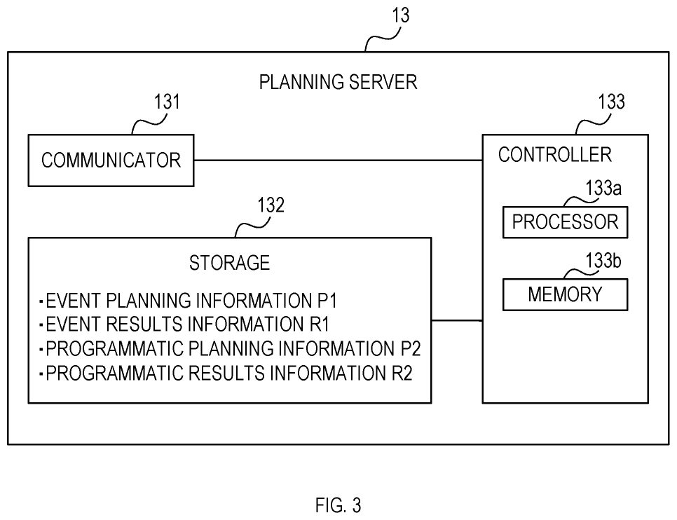

As shown in FIG. 3, the planning server 13 comprises a communicator 131, a storage 132, and a controller 133.

The communicator 131 is a communication interface for connecting the planning server 13 to a network such as the Internet. The planning server 13 communicates data with an external device by wire or wirelessly via the communicator 131. Examples of the external device include the agency server 11 and the advertisement determiner 12. The planning server 13 receives the event planning information P1, the event performance information R1, the programmatic planning information P2, and the programmatic results information R2 from the agency server 11 via the communicator 131.

The storage 132 stores various information. The storage 132, for example, is configured by a hard disk drive. The storage 132 stores the event planning information P1, the event performance information R1, the programmatic planning information P2, and the programmatic results information R2 per advertising campaign of an advertiser that are received from the agency server 11 via the communicator 131. Hereinafter, the event planning information P1, the event performance information R1, the programmatic planning information P2, and the programmatic results information R2 related to the same advertising campaign are collectively referred to as “advertising campaign information”.

The controller 133 supervises and controls each part of the planning server 13. The controller 133 is mainly configured by a known microcomputer having a processor 133a such as a CPU and a GPU, and a semiconductor memory (hereinafter, memory 133b) such as a RAM, a ROM, and a flash memory.

Various functions of the controller 133 are implemented by the processor 133a executing a program stored in a non-transitory tangible storage medium. In this example, the memory 133b corresponds to the non-transitory tangible storage medium that stores the program. Also, by executing this program, a method corresponding to the program is executed. The controller 133 may comprise one or more microcomputers.

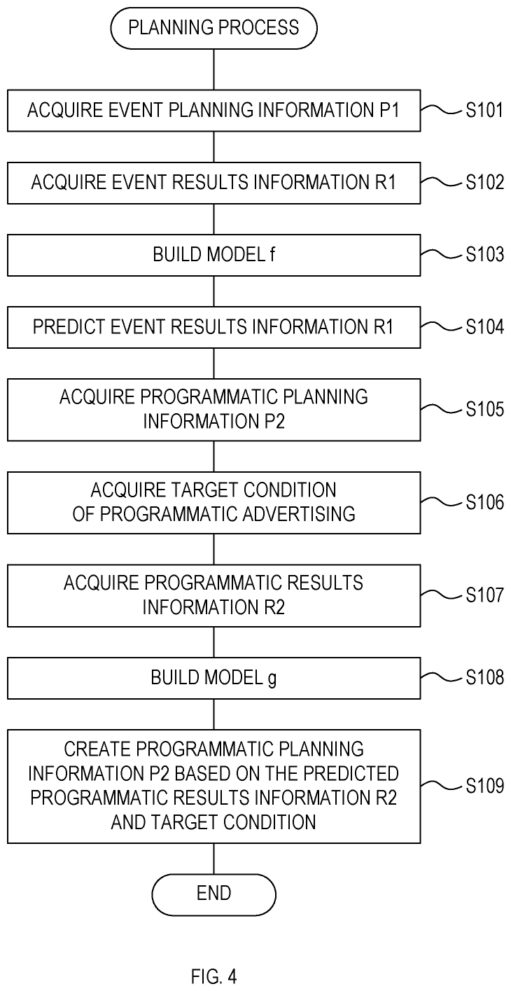

The controller 133, based on the advertising campaign information stored in the storage 132, executes a later-described planning process shown in FIG. 4. As a result of execution of the planning process, the programmatic planning information P2 in the future target period is optimized for each of the advertising campaign information stored in the storage 132.

### 1-2. Process

Next, the planning process executed by the controller 133 of the planning server 13 will be described with reference to a flowchart of FIG. 4. The planning process is executed per the advertising campaign information stored in the storage 132 of the planning server 13. Hereinafter, an advertising campaign related to the advertising campaign information for which the planning process is executed is also referred to as “target advertising campaign”. The planning process is executed one or more times during a campaign period of the target advertising campaign. Execution of the planning process optimizes the programmatic planning information P2 in the future target period. In the present embodiment, as shown in such as FIG. 5, the target period is a period from the present moment to the end of the campaign period of the target advertising campaign.

First, in S101, the controller 133 acquires the event planning information P1 related to the target advertising campaign from the storage 132. Here, the controller 133, as shown in FIG. 5, acquires the event planning information P1 from beginning to end of the campaign period of the target advertising campaign.

Subsequently, in S102, the controller 133 acquires the event results information R1 related to the target advertising campaign from the storage 132. Here, the controller 133, as shown in FIG. 5, acquires the event results information R1 from the beginning of the campaign period of the target advertising campaign to a past certain time point T1.

Subsequently, in S103, the controller 133, based on the event planning information P1 acquired in S101 and the event results information R1 acquired in S102, builds a first prediction model f related to the target advertising campaign, as shown in FIG. 5.

The first prediction model f is a model that enables prediction of the event results information R1 over a certain period of time based on the event planning information P1 over the same period of time. In other words, the first prediction model f is a function f where R1=f(P1). Here, P1 is a parameter included in the event planning information P1. R1 is a parameter included in the event results information R1. The first prediction model f is built using the event planning information P1 and the programmatic results information R2 from the beginning of the campaign period to the past certain time point T1. Specifically, for example, the first prediction model f is built as follows.

That is, the controller 133 acquires contact probability from the number of exposures (total number of contacts) and distribution and statistic of the number of contacts included in the event results information R1 acquired in S102. The contact probability herein is a percentage of the survey panels, among the whole survey panels in a certain segment, that has contacted certain reserved advertising or the like. For example, the controller 133 may acquire the contact probability per the number of contacts. The contact probability per the number of contact, for example, is a percentage of the survey panels, among the whole survey panels in a certain segment, that has contacted certain reserved advertising or the like n times. Also, the controller 133 acquires the above-described reach rate included in the event results information R1.

The controller 133 builds the first prediction model f, using the acquired contact probability and reach rate. Here, the first prediction model f, for example, is built as a function that outputs the number of exposures, distribution and statistic of the number of contacts, and the number of people reached in a posting period and time point of the reserved advertising or the like included in the event planning information P1 when the posting period and time point are inputted.

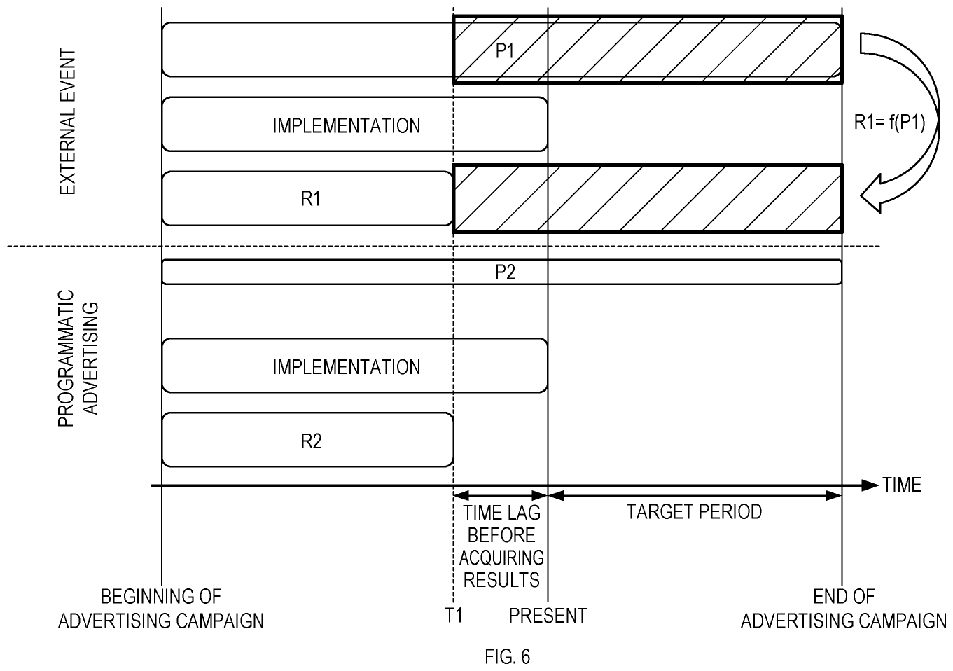

Subsequently, in S104, the controller 133 predicts the event results information R1 in the target period as shown in FIG. 6, based on the event planning information P1 in the target period acquired in S101 and the first prediction model f built in S103.

Specifically, the controller 133, based on the information such as the posting period and time point of the reserved advertising or the like of the event planning information P1 in the target period, calculates a variable related to the event results information R1 in the target period. The variable related to the event results information R1 is, for example, the number of exposures, distribution and statistic of the number of contacts, the number of people reached, etc. for certain reserved advertising or the like in the target period.

Subsequently, in S105, the controller 133 acquires the programmatic planning information P2 related to the target advertising campaign from the storage 132. Here, the controller 133, as shown in FIG. 5, acquires the programmatic planning information P2 from the beginning to the end of the campaign period of the target advertising campaign.

Subsequently, in S106, the controller 133 acquires the target condition related to the target period from the programmatic planning information P2 acquired in S105.

Subsequently, in S107, the controller 133 acquires the programmatic results information R2 related to the target advertising campaign from the storage 132. Here, the controller 133, as shown in FIG. 5, acquires the programmatic results information R2 from the beginning of the campaign period of the target advertising campaign to the past certain time point T1.

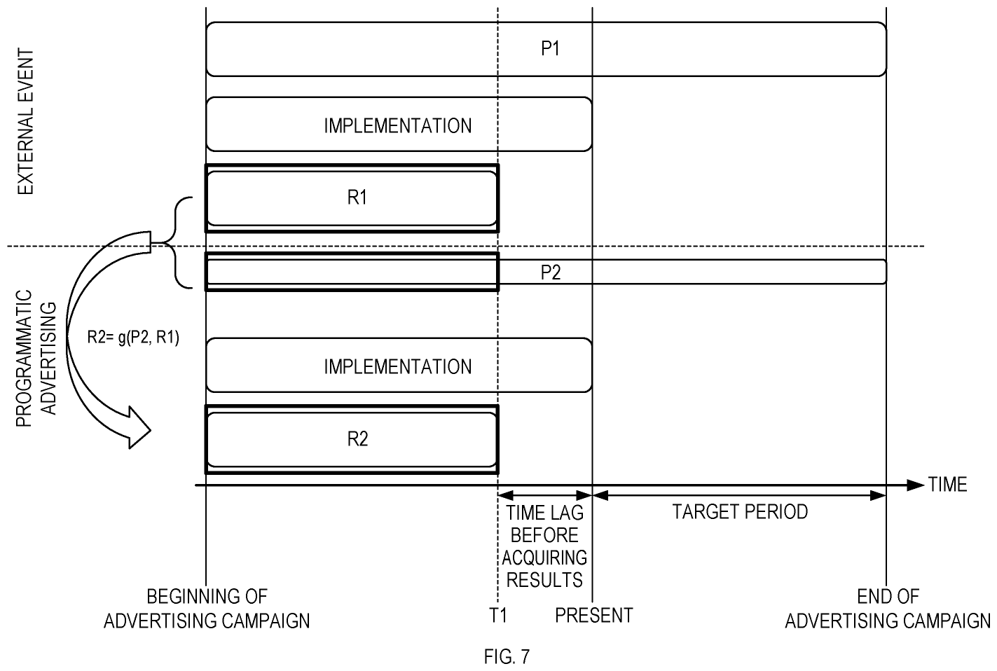

Subsequently, in S108, the controller 133, based on the acquired event results information R1, programmatic planning information P2, and programmatic results information R2, builds a second prediction model g related to the target advertising campaign, as shown in FIG. 7.

The second prediction model g herein is a model that enables prediction of the programmatic results information R2 in a certain period based on the event results information R1 and the programmatic planning information P2 in the same period. In other words, the second prediction model g is a function g where R2=g(R1, P2). Here, RI is a parameter included in the event results information R1. P2 is a parameter included in the programmatic planning information P2. R2 is a parameter included in the programmatic results information R2. The second prediction model g, as shown in FIG. 7, is built using the event results information R1, the programmatic planning information P2, and the programmatic results information R2 from the beginning of the campaign period to the past certain time point T1. Specifically, for example, the second prediction model g is built as below.

First, assume the delivery ON/OFF, the delivery pace, the bid price, and the daily budget that can be set to each time point of the campaign period as variables related to the programmatic planning information P2 among the variables of the second prediction model g. The variable related to the programmatic planning information P2 herein is referred to as “P2 variable” below. On the other hand, among the items of the programmatic planning information P2, the advertisement target, advertisement frame type, advertisement material, and bid condition are fixed (in other words, these items are preconditions). Specifically, for example, a series of plans below (plans from 9:00 to 24:00 on March 13) are examples of the P2 variable inputted to the prediction model g.

March 13 09:00, delivery=ON, delivery pace=standard, bid price=CPC 100 yen, daily budget=10,000 yen

March 13 15:00, delivery=ON, delivery pace=accelerated, bid price=CPC 300 yen, daily budget=10,000 yen

March 13 18:00, delivery=ON, delivery pace=standard, bid price=CPC 100 yen, daily budget=10,000 yen

March 13 21:00, delivery=OFF, delivery pace=standard, bid price=CPC 100 yen, daily budget=10,000 yen

Here, CPC is an abbreviation for Cost per Click, which indicates a payment for one click of an advertisement. In the aforementioned programmatic planning information P2, it is assumed that the event planning information P1 indicates that a television commercial is planned to be placed at 15:00, and the delivery pace is strengthened for three hours from 15:00 (i.e., the delivery pace is set to “accelerated”, and the bid price is set to=CPC 300 yen).

On the other hand, variables related to the event results information R1 among the variables of the second prediction model g are the number of exposures, the number of people reached, etc. at each time point in the campaign period (e.g., each time zone from 9:00 to 24:00). The variable related to the event results information R1 herein is referred to as “R1 variable” below.

In the present embodiment, the second prediction model g having these P2 variable and R1 variable as inputs is built as two functions below. That is, the second prediction model g of the present embodiment includes the following two functions.
Performance(R1, P2)
Spending(R1, P2)

Here, Performance(R1, P2) is a function to output the results of the programmatic advertising at each time point when receiving the P2 variable and the R1 variable. The results herein are assumed to be a KPI (e.g., number of clicks, number of conversions, etc.) to be maximized. On the other hand, Spending(R1, P2) is a function to output the budget consumption at each time point (i.e., advertising costs incurred at each time point) when receiving the P2 variable and the R1 variable.

The controller 133 builds the function Performance to reproduce values such as, for example, the number of clicks and the number of conversions of the programmatic results information R2 from the beginning of the campaign period to the past certain time point T1. Here, for example, the function Performance may be built as a regression analysis model that has the P2 variable and the R1 variable as explanatory variables and the KPI to be maximized as an objective variable. Similarly, the controller 133 builds the function Spending to reproduce the budget consumption of the programmatic results information R2 from the beginning of the campaign period to the past certain time point T1. The controller 133 builds the second prediction model g as such.

For example, in case of search advertising, it is expected that the number of keyword searches largely fluctuates due to the influence of the external event such as a television commercial or the like, and the advertising inventory increases. Also, depending on the bid price of the programmatic advertising, win rate in an auction, and presence or absence and position of advertisement fluctuate. It is expected that probability that the search advertising is clicked when viewed by a user increases due to an appeal effect of the television commercial or the like. Thus, it is expected that the KPI such as the budget consumption and the click-through rate fluctuate by the event planning information P1 and the programmatic planning information P2 of the external event.

Also, for example, in case of image advertising such as video advertising, advertising inventory is less likely to be affected by a television commercial or the like, and mostly depends on a page view (PV) for each time zone of the posting page. Also, win rate in an auction, and presence or absence and position of the advertisement fluctuate, depending on the bid price of the programmatic advertising. It is expected that probability for the image advertising to be clicked when viewed by a user increases due to an appeal effect of the television commercial or the like. Thus, it is expected that the KPI such as the budget consumption and the click-through rate fluctuate by the event planning information P1 of the external event and the programmatic planning information P2. The second prediction model g that reflects these features is built by the above-described building method.

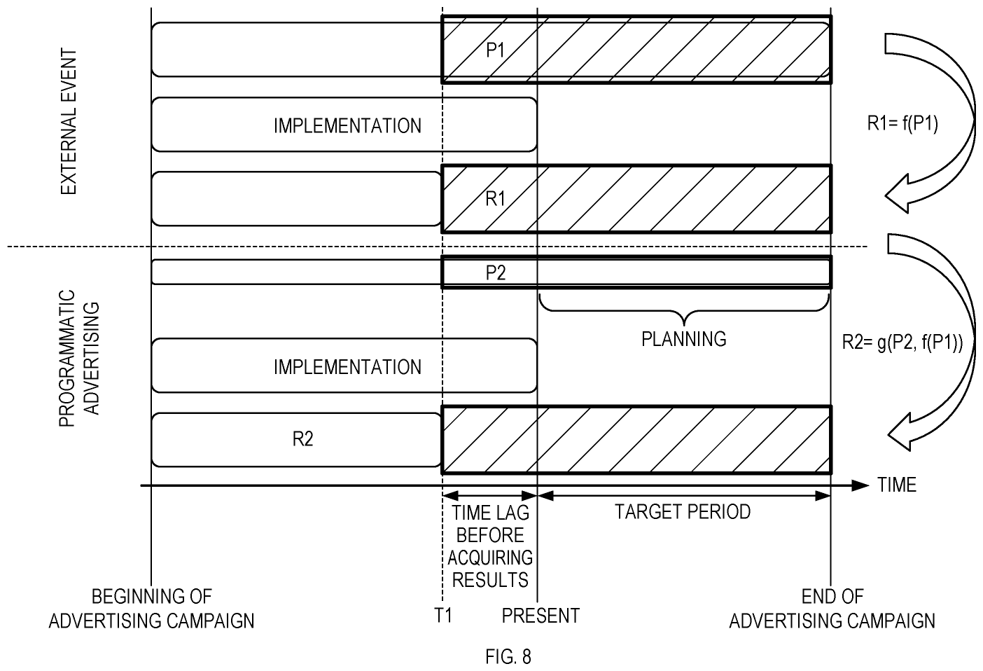

Subsequently, in S109, the controller 133 predicts the programmatic results information R2 in the target period based on the event results information R1 in the target period predicted in S104, the programmatic planning information P2 in the target period acquired in S105, and the second prediction model g built in S108. Then, the controller 133, as shown in FIG. 8, optimizes the programmatic planning information P2 in the target period based on the programmatic results information R2 in the predicted target period and the target condition acquired in S106.

Specifically, the controller 133 optimizes the programmatic planning information P2 in the target period as follows. That is, the controller 133 uses the R1 variable predicted using the first prediction model f (e.g., number of exposures, number of people reached, etc.) as the R1 variable to be used in the prediction model g. Then, the controller 133 fluctuates the P2 variable to generate multiple pieces of programmatic planning information P2. In the present embodiment, the P2 variable indicates the delivery ON/OFF, delivery pace, bid price, and daily budget.

The controller 133 then uses the second prediction model g (i.e., function

Performance and function Spending) to predict the results of the programmatic advertising and the budget consumption in the target period for each of the generated multiple pieces of the programmatic planning information P2. Then, the programmatic planning information P2 that makes a value indicated by Performance(f(P1), P2) the results shown by the target condition is selected from the multiple pieces of programmatic planning information P2. For example, in case that the target condition is to maximize the KPIs such as the number of clicks and the number of conversions, the programmatic planning information P2 that maximizes these KPIs is selected from the multiple pieces of programmatic planning information P2.

However, it is not desirable that there is much budget left or a budget overrun. Here, the budget left is represented as a value obtained by subtracting the budget amount from a predicted value of the function Spending. Also, the budget overrun is represented as a value obtained by subtracting the predicted value of the function Spending from the budget amount. In other words, it is desirable that, at each time point of the campaign period, the predicted value of Spending(f(P1), P2) is approximately equal to the budget amount.

Thus, in the present embodiment, the multiple pieces of programmatic planning information P2 are generated so that Spending(f(P1), P2) satisfies the following two conditions (conditions A and B).

(Condition A) A total amount of the programmatic advertising costs (i.e., sum of the function Spending) in the entire campaign period is the budget amount of the programmatic advertising set in advance. In other words, a difference between the sum of the function Spending and the total budget amount of the programmatic advertising set in advance is within a specified value.

(Condition B) The budget consumption (i.e., predicted value of the function Spending) at each time point of the programmatic advertising is the budget amount at each time point. In other words, the budget consumption (i.e., predicted value of the function Spending) at each time point follows the schedule of the budget consumption included in the programmatic planning information P2. In the present embodiment, a difference between the daily budget which is a budget plan on a daily basis and the value of the function Spending which is the budget consumption on a daily basis is within a specified value.

The controller 133 selects, from the multiple pieces of programmatic planning information P2 that satisfy the conditions A and B, the programmatic planning information P2 of which the programmatic results information R2 is closest to a condition indicated by the target condition. This changes or modifies the initial programmatic planning information P2 in the target period, and the programmatic planning information P2 is optimized.

The controller 133, when executing S109, ends the planning process of FIG. 4.

### 1-3. Effect

According to the embodiment detailed above, the following effects are achieved.

(1) In the present embodiment, the controller 133 predicts the programmatic results information R2 in the target period based on the event planning information P1, the programmatic planning information P2, and the prescribed prediction models f and g in the target period. Then, the controller 133 creates the programmatic planning information P2 so that the predicted programmatic results information R2 approaches the results indicated in the target condition.

In other words, the controller 133 creates the programmatic planning information P2 in the target period based on the event planning information P1 of the external event such as a television commercial. Accordingly, by considering the influence of the external event as an external factor in the target period, it is possible to improve estimation accuracy of the programmatic planning information P2 to achieve the targeted results.

The “results indicated in the target condition” in the present embodiment include not only the results that the prescribed KPI exceeds or falls below a prescribed threshold and the results that the prescribed KPI matches a certain value, but also the results that the prescribed KPI is maximized or minimized. Specifically, for example, the results that the number of conversions and the number of clicks are maximized and the results that a CPM (cost per thousand impressions) is minimized are also included. In other words, the controller 133 may create the programmatic planning information P2 so that the prescribed KPI is maximized or minimized.

(2) In the present embodiment, the event planning information P1 includes information on a reserved advertising delivery, planning information on a press release for goods or services related to the advertising campaign, and planning information on an exhibition for the goods or services, and information indicating a content schedule. Accordingly, by considering the information on the reserved advertising delivery plan, etc., it is possible to improve estimation accuracy of the programmatic planning information P2 to achieve the targeted results.

(3) In the present embodiment, the controller 133 first uses the first prediction model f to predict the event results information R1 in the target period. The controller 133 then uses the second prediction model g to predict the programmatic results information R2 in the target period, based on the predicted event results information R1 and the programmatic planning information P2 in the target period. Then, the controller 133 creates the programmatic planning information P2 so that the predicted programmatic results information R2 approaches the results indicated in the target condition.

The programmatic results information R2 is not affected by the event planning information P1 itself, but is affected by the event results information R1 which is the results of the event planning information P1. Thus, estimation accuracy of the programmatic results information R2 can be improved by acquiring the event results information R1 once and predicting the programmatic results information R2 based on the acquired event results information R1. Accordingly, for example, as compared with predicting the programmatic results information R2 without predicting the event results information R1 from the event planning information P1, it is possible to improve estimation accuracy of the programmatic results information R2 to achieve the targeted results.

(4) In the present embodiment, the controller 133 creates the programmatic planning information P2 based on the preset budget amount. Accordingly, the programmatic planning information P2 can be created to approach the results indicated in the target condition while satisfying the set budget amount.

(5) Specifically, in the present embodiment, the controller 133 creates the programmatic planning information P2 such that the total programmatic advertising cost in the entire campaign period of the target advertising campaign is the budget amount specified by the advertiser at the end of the campaign period. More specifically, the controller 133 creates the programmatic planning information P2 in the target period such that the programmatic results information R2 in the target period is maximized while satisfying the condition that the programmatic advertising costs from the beginning of the campaign period are the preset budget amount at the end of the campaign period.

For example, if the budget is used up in the first half of the campaign period, opportunities such as for conversion may be lost in the second half of the campaign period. Also, if the set budget amount is not used up within the campaign period, opportunities for conversion may be lost as well. Thus, according to the configuration of the present embodiment, loss of opportunities such as for conversion can be reduced.

(6) Further, in the present embodiment, the programmatic planning information P2 is created such that the advertising costs follow the schedule of the budget consumption included in the programmatic planning information P2. In other words, the programmatic planning information P2 is created such that the programmatic advertising costs in each of the multiple periods obtained by dividing the future target period are the budget amount in the corresponding period.

For example, advertisement may not be much delivered in the first half of the campaign period, and the budget for the first half of the campaign period may not be used up. Then, the advertisement may be much delivered in the second half of the campaign period, and the budget in the entire campaign period may be used up. In such cases, the budget is used up in the entire campaign period. However, in the first half of the campaign period, opportunities such as for conversion may be lost. Accordingly, by appropriately delivering advertisement so that the programmatic advertising costs in each of the multiple periods of the target period are the budget amount in the corresponding period, loss of opportunities such as for conversion can be reduced.

In the present embodiment, the planning server 13 corresponds to a planning device, the step of S101 corresponds to a process as an event plan acquirer, the step of S104 corresponds to a process as a first predictor, the steps of S104 and S109 correspond to a process as a planner, the step of S105 corresponds to a process as a programmatic planning acquirer and a budget acquirer, the step of S106 corresponds to a process as a target condition acquirer, and the step of S109 corresponds to a process as a second predictor and a planning processor.

### 2. Second Embodiment

### 2-1. Difference from First Embodiment

The second embodiment has a basic configuration similar to that of the first embodiment and therefore, the description of the common configuration will be omitted, and the difference will be mainly described. The same reference numerals as those in the first embodiment indicate the same configuration, and reference is made to the preceding description.

The planning system 1 of the second embodiment has the same hardware configuration as that of the planning system 1 of the first embodiment. However, the second embodiment is partly different from the first embodiment in the planning process executed by the controller 133 of the planning server 13. In detail, as described later, additional steps to those of the first embodiment are executed in the planning process of the second embodiment.

### 2-2. Process

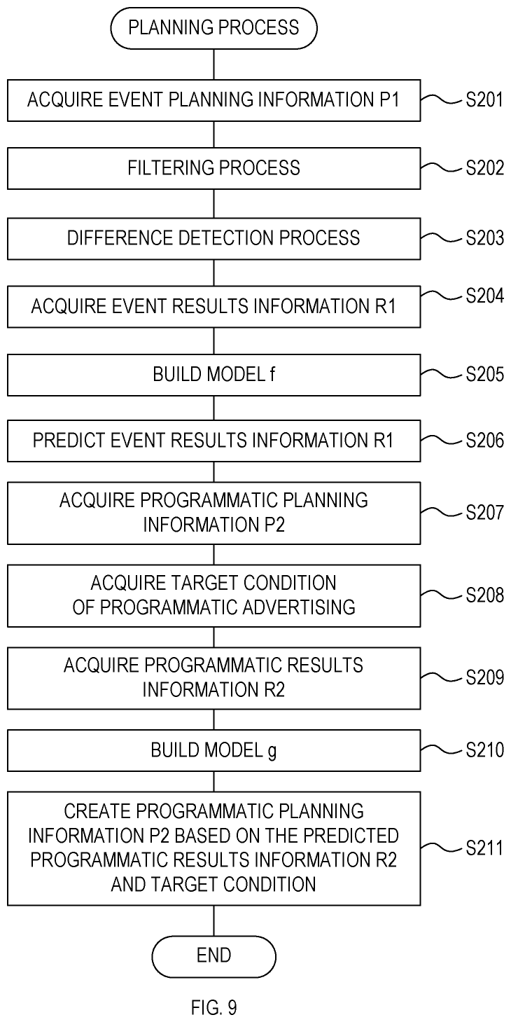

Next, the planning process executed by the controller 133 of the planning server 13 of the second embodiment will be described with reference to a flowchart of FIG. 9.

A step of S201 is the same step as S101 of FIG. 4 described above, and thus the description is not repeated.

In S202, the controller 133 executes a filtering process on the event planning information P1 acquired in S201.

The filtering process is a process to extract event planning information which can affect specific programmatic advertising from the event planning information P1 acquired in S201. The specific programmatic advertising herein means programmatic advertising for which a delivery plan is created in the planning process of FIG. 9. Hereinafter, this specific programmatic advertising is referred to as “target programmatic advertising”.

Specifically, the event planning information P1 acquired in S201 may include the event planning information P1 which cannot affect the target programmatic advertising. For example, in case that a television program guide is acquired as the event planning information P1, there may be a television program which may affect the target programmatic advertising as well as a television program which cannot affect the target programmatic advertising, in the television program guide. In this case, the controller 133 extracts the television program which may affect the target programmatic advertising from the acquired television program guide.

Specifically, the controller 133 first accepts settings for an extraction condition. The extraction condition is a condition for extracting the event planning information P1 which may affect the target programmatic advertising. In other words, the filtering process in S202 may be a process to extract the specific event planning information P1 which satisfies the extraction condition from the event planning information P1 acquired in S201. The extraction condition, for example, may be set by a user.

In the present embodiment, the extraction condition is that the external event of the event planning information P1 satisfies the delivery condition of the programmatic advertising. Specifically, the extraction condition is to satisfy all of the following conditions (a) to (c):

(a) implementation period of the external event matches delivery time of the programmatic advertising;

(b) implementation area of the external event matches a delivery district of the programmatic advertising; and

(c) implementation detail of the external event matches delivery detail of the programmatic advertising.

Various conditions are assumed for the above condition (c). For example, the condition (c) may be that at least one of the following is common between the external event and the programmatic advertising.
Name of goods, services, or brands (e.g., AIU pencil)
Provider of goods or services (e.g., AIU Corporation)
Name of competing goods, services or brands (e.g., PAPIPU pencil)
Components or features of goods, services or brands (e.g., high-performance graphite)
Functions or benefits of goods, services or brands (e.g., written line does not become blurred)
Customer problem solved by goods or services (e.g., hands get dirty)
Use scene of goods or services (e.g., school lessons)
Category name of goods or services (e.g., pencil)
Representation in campaign of goods or services (e.g., AIU pencils generate no blurring)

The controller 133, when accepting the setting of the extraction condition, executes a matching (i.e., combining) process between the element of the external event included in the event planning information P1 and the element of the programmatic advertising. Here, the controller 133, in case that the programmatic advertising is formed of multiple operational units, performs matching as to which operational unit the extracted event planning information is used for. Examples of the case where the programmatic advertising is formed of multiple operational units include a case where the target programmatic advertising is formed of multiple pieces of programmatic advertising that are different in at least one of the delivery time, delivery district, and delivery detail.

The controller 133 determines whether the event planning information satisfies the extraction condition in each combination obtained by the matching, and extracts the event planning information P1 which satisfies the extraction condition. The controller 133 executes the filtering process as such.

In S203, the controller 133 executes a difference detection process on the event planning information P1 extracted in the filtering process in S202. The difference detection process herein is a process to detect an update of the event planning information P1, in other words, a difference between the already acquired event planning information P1 and the event planning information P1 acquired in the latest step of S201 and extracted in the filtering process in S202.

That is, in case that the planning process of FIG. 9 has been executed before and the step of S201 has been executed before, the controller 133 has acquired the event planning information P1. In the present embodiment, when the event planning information P1 is acquired in S201, all the event planning information P1 stored in the storage 112, including the already acquired event planning information P1, are acquired in a lump.

Here, the controller 133 detects the update from the previously acquired event planning information P1, and updates the models f and g using the detected update. Thus, it is considered possible to reduce time to update the prediction models f and g. The update from the previously acquired event planning information P1 is, in other words, information stored in the storage 112 anew.

Thus, the controller 133, in S203, executes the difference detection process for detecting the update of the event planning information P1.

In case that the event planning information P1 has not been acquired before, the difference detected in the difference detection process in S203 is all of the event planning information P1 extracted in the filtering process in S202.

Subsequently, in S204, the controller 133 acquires the event results information R1 related to the target advertising campaign from the storage 132.

Here, the controller 133 acquires the event results information R1 corresponding to the difference in the event planning information P1 detected in S203 from among the event results information R1 from the beginning of the campaign period of the target advertising campaign to the past certain time point T1.

Subsequently, in S205, the controller 133 builds the first prediction model f related to the target advertising campaign. The step of S205 is basically the same step as S103 of FIG. 4 described above. If the first prediction model f is already built, the controller 133, in S203, updates the already built first prediction model f using the difference of the detected event planning information P1 and the event results information R1 corresponding to the difference.

Steps S206 to S209 are the same steps as S104 to S107 of FIG. 4 described above, and thus the description thereof is not repeated.

Subsequently, in S210, the controller 133 builds the second prediction model g related to the target advertising campaign based on the acquired event results information R1, programmatic planning information P2 and programmatic results information R2. The step of S210 is basically the same step as S108 of FIG. 4 described above.

If the second prediction model g has been already built, the second prediction model g is updated in S210. Specifically, the second prediction model g is updated based on the update of the event results information R1 acquired in S204, the programmatic planning information P2 acquired in S207, and the programmatic results information R2 acquired in S208.

Step of S211 is the same step as S109 of FIG. 4 described above, and thus the description thereof is not repeated.

### 2-3. Effect

According to the second embodiment detailed in the above, the following effects are achieved, in addition to the above-described effects (1) to (6) of the first embodiment.

(1) In the present embodiment, the controller 133 executes the filtering process in S202. In the filtering process, the event planning information P1 that may affect the results of the target programmatic advertising is extracted from the event planning information P1 acquired in S201.

Accordingly, since the event planning information P1 extracted by the filtering process is used to build and update the prediction models f and g, calculation amounts of the prediction models f and g are reduced and prediction accuracy can be improved. Also, since the event planning information P1 extracted by the filtering process is used to make prediction with the prediction models f and g, the calculation amounts of the prediction models f and g are reduced and prediction accuracy can be improved.

(2) In the present embodiment, the controller 133 executes the difference detection process in S203 on the event planning information P1 acquired in S201. Then, the controller 133 updates the prediction models f and g using the differences detected in S205 and S210.

Accordingly, as compared with the case where all the event planning information including the already acquired event planning information are used to update the prediction models f and g, the time to update the prediction models f and g can be reduced.

In the present embodiment, the step of S201 corresponds to the process as the event plan acquirer, the step of S202 corresponds to a process as a filter, the step of S203 corresponds to a process as a difference detector, the steps of S205 and S210 correspond to a process as an update processor, the step of S206 corresponds to the process as the first predictor, the steps of S206 and S211 correspond to the process as the planner, the step of S207 corresponds to a process as the programmatic planning acquirer and a budget acquirer, the step of S208 corresponds to the process as the target condition acquirer, and the step of S211 corresponds to the process as the second predictor and the planning processor.

### 3. Other Embodiments

Although the embodiments for implementing the present disclosure have been described above, the present disclosure is not limited to the above-described embodiments, and various modifications can be made.

(1) In each of the above-described embodiments, the planning server 13 predicts the programmatic results information R2 in the target period in the form of the function R2=g(f(P1), P2) using the two prediction models f and g. However, how to predict the programmatic results information R2 is not limited to this. For example, a function h that satisfies a function R2=h(P1, P2) may be directly found, and the function h may be used to predict the programmatic results information R2 in the target period. In other words, a function for predicting R2 based on P1 and P2 may not be divided into two functions f and g, and may be obtained as a single function h.

(2) In each of the above-described embodiments, the second prediction model g is built as the two divided functions Performance and Spending. However, how to build the second prediction model g is not limited to this. For example, the second prediction model g may be built without being divided into the above two functions.

(3) In each of the above-described embodiments, examples of the P2 variable used in building the second prediction model g are the delivery ON/OFF and the delivery pace, and examples of the R1 variable are the total number of contacts and the number of reaches. However, the P2 variable and R1 variable to be used are not limited to these. For example, behavior change probability and the number of keyword searches may be also used. The behavior change probability indicates how many contacts to certain reserved advertising or the like are required to change behavior of a target person about the goods or services related to the reserved advertising or the like. Behavior change means having recognition, awareness, comprehension, purchase motivation, and so on.

(4) The method for creating the programmatic planning information P2 in each of the above-described embodiments is merely an example, and other methods may be used to create the programmatic planning information P2. For example, the programmatic planning information P2 may be created such that the programmatic advertising costs in a first period are greater than the programmatic advertising costs in a second period. Here, the first period is a portion of the target period during which an external event such as a television commercial is implemented or the results of the external event are equal to or greater than a first threshold. The period during which the results of the external event are equal to or greater than the first threshold is, for example, a period during which the influence of the external event remains to some extent. The second period is a portion of the target period during which an external event such as a television commercial is not implemented or the results of the external event are equal to or smaller than a second threshold. The period during which the results of the external event are equal to or smaller than the second threshold is, for example, a period during which the influence of the external event remains but is small. The second threshold is a value equal to or smaller than the first threshold.

With the configuration as such, the results of the programmatic advertising can be increased. Specifically, it is expected that the number of keyword searches for the goods or services related to the advertising campaign will increase in the first period as compared with that in the second period. In other words, while the same daily budget is normally set every day (or for each day), it is expected that the number of keyword searches will increase in a period during which the external event such as a television commercial is implemented. Thus, as in the configuration above, by increasing the programmatic advertising costs in the period during which the number of keyword searches increases, the results of the programmatic advertising such as impressions can be increased.

Also, for example, contrary to the above, the programmatic planning information P2 may be created such that the programmatic advertising costs in the first period are smaller than the programmatic advertising costs in the second period.

For example, there may be a case where a budget for search advertising is reduced when the goods or services are taken up in a program of a contents output device such as a television program. The reason is because there are cases where a conversion rate of website visitors who react to the program of the contents output device is significantly low, or there is sufficient inflow of users by natural searching and not by search advertising. Thus, according to the above-described configuration, cost-effectiveness can be improved based on the event planning information P1 and the predicted results of the event planning information P1.

(5) In each of the above-described embodiments, the planning server 13 may create the programmatic planning information P2 in consideration of only the influences of some, not all, of the information on the reserved advertising delivery plan, the planning information on a press release for the goods or services related to the advertising campaign, the planning information on an exhibition for the goods or services, and the information indicating the content schedule.

(6) In each of the above-described embodiments, the programmatic planning information P2 may be created without imposing the condition that the total programmatic advertising cost in the entire campaign period of the advertising campaign is the budget amount at the end of the campaign period.

(7) In each of the above-described embodiments, the programmatic planning information P2 may be created without imposing the condition that the programmatic advertising costs in each of the multiple periods in the target period are the budget amount in the corresponding period.

(8) In each of the above-described embodiments, the event planning information P1 may include feasibility information. The feasibility information indicates a degree of possibility that the external event is implemented. The controller 133, based on the feasibility information, may create the programmatic advertising delivery plan in the target period. Here, the feasibility information may be, for example, implementation probability information that reflects a probability that the external event is implemented. The feasibility information, for example, may represent the implementation probability as a percentage, or indicate a degree of ease of implementation by “high, medium, low” etc.

Specifically, since the event planning information P1 is information about the future, implementation of the external event related to the event planning information P1 is uncertain. Thus, by adding the feasibility information to the event planning information P1, a degree to which the external event will be implemented is reflected, and the programmatic advertising can be optimized.

How to acquire the feasibility information is not particularly limited. For example, there are cases where a data provider who provides the event planning information P1 provides the event planning information P1 to which the feasibility information is added. In that case, the event planning information P1 including the feasibility information provided by the data provider may be stored in the storage 112. Also, the planning server 13 may use update history of the past event planning information P1 and history information of a result of implementation of the external event related to the event planning information P1, so as to estimate the degree of possibility that the same type of external event is implemented. Then, the event planning information P1 including the feasibility information that indicates the estimated degree may be stored in the storage 112.

Specifically, the controller 133 may create the programmatic advertising delivery plan in the target period based on the feasibility information as follows, for example.

That is, for example, assume that the inventory and the click-through rate of search advertising are predicted to increase in a specified period of time (e.g., 3 hours) from when there is “broadcasting of a television commercial” as an external event. Then, assume that, although a broadcasting time frame of the television commercial is fixed to a specified time frame (e.g., 15:00-16:00), it is uncertain at which time point in the specified time frame there is the broadcasting of a television commercial. In this case, it is conceivable to add the feasibility information that the time point when there is the broadcasting of a television commercial shows uniform distribution within the specified time frame, and allocate a time zone delivery budget for the programmatic advertising within the specified time frame and/or around the time frame. For example, if the time zone delivery budget, when it is certain that the television commercial is broadcast at exactly 15:00, is set to 100%, the budget may be allocated at 50% between 15:00 and 16:00, 100% between 16:00 and 18:00, and 50% between 18:00 and 19:00.

In other words, based on the feasibility information that indicates the degree of possibility that the external event occurs at one or more time points or any time point in the specified time zone, the delivery budget for the programmatic advertising may be allocated in the specified time zone and/or around the time zone.

Also, for example, assume a case where it is expected that a broadcasting frame of a certain program is to be extended for a specified period of time at a specified probability in contents starting at specified time. Specifically, for example, assume a case where it is expected that a two-hour frame of sports broadcasting in a television program starting from 19:00 is to be extended for an hour at a probability of 50%. In this case, allocation of the time zone delivery budget for the programmatic advertising of the related delivery detail may be like 80% between 19:00 and 21:00, and 40% at 21:00 and 22:00. Here, the time zone delivery budget when it is certain that the television program fits a pre-planned broadcasting frame (i.e., the program is not extended) is 100%. Also, the programmatic advertising of the related delivery detail is, for example, programmatic advertising related to sportswear.

In other words, based on the feasibility information that indicates the degree of possibility that the time zone during which the external event is implemented fluctuates by a specified fluctuation amount from the specified time zone planned in advance, the delivery budget amount of the programmatic advertising may be allocated in the specified time zone and/or around the time zone.

(9) In each of the above-described embodiments, the controller 133 acquires later-revealed information after the external event is started. The controller 133 may create the programmatic advertising delivery plan based on the acquired later-revealed information. Here, the later-revealed information is information on the external event that is revealed after the external event is started.

For example, the controller 133 may set the delivery budget for the programmatic advertising after the external event is started based on the later-revealed information as follows.

That is, for example, assume a baseball broadcast on television as the external event. In this baseball broadcast, Team A and Team B play a game.

When the baseball game is broadcast, and Team A wins, it is predicted that the inventory and the click-through rate of search advertising of goods and services related to Team A increase. On the other hand, when Team B wins, it is predicted that the inventory and the click-through rate of search advertising of goods and services related to Team A will not increase so much.

Thus, when the baseball game is broadcast, and it is revealed that Team A has won, it is conceivable to allocate a large amount of budget for the programmatic advertising of the goods and services related to Team A. In this case, information indicating the result of the game corresponds to the later-revealed information. The result of the game may be that Team A or Team B wins.

The controller 133, before the implementation of external event that is the baseball broadcast on television, allocates the budget for the programmatic advertising based on the event planning information P1 of the external event. The programmatic advertising herein is the programmatic advertising of the goods and services related to Team A. When allocating the budget, the controller 133, assuming a case where Team A wins, does not completely consume the delivery budget for the programmatic advertising, and sets the delivery budget for the programmatic advertising with a fixed budget amount being left.

The controller 133, after the baseball broadcast is started, acquires the later-revealed information indicating that Team A has won. The controller 133, based on the acquired later-revealed information, may set the budget amount which has been left to the delivery budget for the programmatic advertising.

That is, the controller 133, before the implementation of the external event, sets the delivery budget for the programmatic advertising so that the delivery budget for the programmatic advertising is not completely consumed. The controller 133 acquires the later-revealed information after the external event is started. The controller 133, based on the acquired later-revealed information, may set all or part of the budget left to the delivery budget for the programmatic advertising when a specific fact is revealed.

With the configuration as such, as compared with a case where the later-revealed information is not used to set the programmatic advertising delivery plan, results of the programmatic advertising can be improved by creation of the delivery plan most suitable for the programmatic advertising based on the prediction.

(10) In each of the above-described embodiments, the first prediction model f, the second prediction model g, and the prediction model h that satisfies R2=h(P1, P2) may be built as machine learning models.

In this case, for example, in S103 of FIGS. 4 and 205 of FIG. 9, the event planning information P1 and the programmatic results information R2 from the beginning of the campaign period to the past certain time point T1 may be used as learning data to learn the first prediction model f. Also, for example, in S108 of FIGS. 4 and S210 of FIG. 9, the event results information R1, the programmatic planning information P2, and the programmatic results information R2 from the beginning of the campaign period to the past certain time point T1 may be used as learning data to learn the second prediction model g. Also, for example, the event planning information P1, the programmatic planning information P2, and the programmatic results information R2 from the beginning of the campaign period to the past certain time point T1 may be used as learning data to learn the prediction model h.

The machine learning model to be used is not particularly limited. For example, the machine learning model may be generated through machine learning by at least one of methods of neural network, support vector machine, decision tree, Bayesian network, linear regression, multivariate analysis, logistic regression analysis, etc.

With the configuration as such, prediction accuracy of the prediction models f and g can be improved by learning the prediction models f and g. As a result, the results of the programmatic advertising can be improved by creation of the delivery plan most suitable for the programmatic advertising based on the prediction.

The steps of S103, S108, S205 and S210 correspond to a process as a learner.

(11) In the above-described second embodiment, the extraction condition for extracting the event planning information P1 is to satisfy all the conditions (a) to (c) above, but the extraction condition is not limited to this. For example, the extraction condition may be satisfying one or two of the above conditions (a) to (c).

(12) In each of the above-described embodiments, the learning data of the model that predicts the programmatic results information R2 (the second prediction model g, the prediction model h that satisfies R2=h(P1, P2), etc.) may be extracted as follows, for example.

That is, the past programmatic results information R2 highly relative to the event planning information P1 of the external event may be extracted as the learning data. In other words, the programmatic results information R2 that satisfies a relevance condition may be extracted from the past programmatic results information R2.

The relevance condition herein is a specific condition indicating that relevance to the event planning information P1 of the external event is above a certain level. The extracted past programmatic results information R2 may be used to learn the prediction model.

Here, the relevance condition, for example, is satisfying at least one of conditions (A) to (D) below. In the conditions (A) to (D) below, “the programmatic advertising” means programmatic advertising related to the past programmatic results information R2.

(A) The programmatic advertising and an external event are identical or similar in delivery condition. The delivery condition, for example, indicates delivery time such as seasons, delivery district, and so on.

(B) The programmatic advertising and an external event are identical or similar in attribute of a delivery target. The attribute of a delivery target, for example, indicates a demographic attribute, a geographic attribute, a psychographic attribute, and so on.

(C) Goods, services or brands to be appealed of the programmatic advertising and an external event are identical to each other or belong to the same category.

(D) The type of the past external event that has affected the programmatic advertising and the type of a future external event that is planned in the event planning information P1 are identical or similar to each other.

(13) In the above-described second embodiment, the difference detection process is executed in S203. Then, using the detected difference, that is, the update from the previously acquired event planning information P1, updating or the like of the prediction models f and g is performed. However, information for use in updating or the like of the prediction model is not limited to this.

For example, even if the event planning information P1 has already been acquired before, the controller 133 acquires all the event planning information P1 stored in the storage 132 in a lump. Using all the event planning information P1 acquired in a lump, updating or the like of the prediction models f and g may be performed. In other words, using not only the update from the previously acquired event planning information P1 but also the already acquired event planning information P1, updating or the like of the prediction models f and g may be performed. The same applies to the prediction model h.

(14) In each of the above-described embodiments, the planning device is implemented as a single planning server 13. However, implementation of the planning device is not limited to this. For example, the planning device may be implemented by multiple servers. Also, in each of the above-described embodiments, at least two of the agency server 11, the advertisement determiner 12 and the planning server 13 may be implemented as a single server.

(15) In each of the above-described embodiments, a part or all of the functions executed by the controller 133 of the planning server 13 may be configured in hardware, using one or more ICs or the like.

(16) In addition to the above-described planning server 13, the present disclosure may be implemented in various modes such as the planning system 1 comprising the planning server 13 as a component, a computer program for causing a computer to function as the planning server 13, a non-transitory tangible storage medium such as a semiconductor memory storing the computer program, and a method for creating a programmatic advertising delivery plan.

(17) The functions of one component in the above-described embodiments may be performed by two or more components. One function of one component may be performed by two or more components. The functions performed by two or more components may be performed by one component. One function performed by two or more components may be performed by one component. Part of the configuration of the above-described embodiments may be omitted. At least part of the configuration of one of the above-described embodiments may be added to or replaced with other configuration of another one of the above-described embodiments. All modes included in the technical idea defined by the language of the claims are embodiments of the present disclosure.

1. A planning device for creating a programmatic advertising delivery plan related to a target advertising campaign, the planning device comprising:
an event plan acquirer configured to acquire event planning information, the event planning information being planning information on an external event in a future target period, the external event being an event of which implementation is plannable in advance, of which implementation or notification of the implementation affects results of programmatic advertising, and which is different from programmatic advertising delivery;
a target condition acquirer configured to acquire target condition information indicating a target condition, the target condition being a condition related to results of the programmatic advertising in the target period; and
a planner configured to predict the results of the programmatic advertising in the target period based on the event planning information, the programmatic advertising delivery plan in the target period, and a prescribed prediction model, and create the programmatic advertising delivery plan in the target period so that the predicted results approach results indicated in the target condition information, the prediction model being a model for predicting the results of the programmatic advertising based on the event planning information and the programmatic advertising delivery plan.

2. The planning device according to claim 1,
wherein the event planning information includes at least one of: information on a reserved advertising delivery plan; planning information on a press release for goods or services related to the advertising campaign; planning information on an exhibition for the goods or services; and information indicating a broadcast schedule or a delivery schedule of a program of a contents output device that outputs contents.

3. The planning device according to claim 1 or 2, further comprising:
a programmatic planning acquirer configured to acquire the programmatic advertising delivery plan in the target period,
wherein the prediction model comprises a first prediction model and a second prediction model,
the first prediction model being a model that enables prediction of results of the external event based on the event planning information, and the second prediction model being a model that enables prediction of the results of the programmatic advertising based on the results of the external event and the programmatic advertising delivery plan,
wherein the planner comprises:
a first predictor configured to use the first prediction model to predict the results of the external event in the target period based on the event planning information;
a second predictor configured to use the second prediction model to predict the results of the programmatic advertising in the target period based on the results of the external event in the target period predicted by the first predictor and the programmatic advertising delivery plan in the target period; and
a planning processor configured to change the programmatic advertising delivery plan in the target period so that the results of the programmatic advertising in the target period predicted by the second predictor approach the results indicated in the target condition information.

4. The planning device according to claim 1, further comprising:
a budget acquirer configured to acquire information on a budget amount related to programmatic advertising delivery in the target period,
wherein the planner creates the programmatic advertising delivery plan in the target period based on the budget amount.

5. The planning device according to claim 4,
wherein the planner creates the delivery plan such that a total programmatic advertising cost in an entire campaign period of the advertising campaign is the budget amount at an end of the campaign period.

6. The planning device according to claim 4 r 5,
wherein the information on the budget amount includes information on a budget amount in each of multiple periods obtained by dividing the target period,
wherein the planner creates the delivery plan such that programmatic advertising costs in each of the multiple periods are the budget amount in the corresponding period.

7. The planning device according to claim 1,
wherein the planner creates the delivery plan such that programmatic advertising costs in a first period are greater or smaller than programmatic advertising costs in a second period, the first period being a portion of the target period during which the external event is implemented or the results of the external event are equal to or greater than a first threshold, the second period being a portion of the target period during which the external event is not implemented or the results of the external event are equal to or smaller than a second threshold, the second threshold being equal to or smaller than the first threshold.

8. The planning device according to claim 1, further comprising:
a learner configured to use learning data to learn the prediction model,
wherein the learning data includes the past event planning information, the past programmatic advertising delivery plan, and the past results of the programmatic advertising.

9. The planning device according to claim 1, further comprising:
a filter configured to execute a filtering process on the event planning information acquired by the event plan acquirer,
wherein the filtering process is a process to extract the event planning information which affects results of specific programmatic advertising from the event planning information acquired by the event plan acquirer.

10. The planning device according to claim 1, further comprising:
a difference detector configured to execute a difference detection process on the event planning information acquired by the event plan acquirer, the difference detection process being a process to detect a difference between the event planning information acquired by the event plan acquirer and the already acquired event planning information, and
an update processor configured to use the difference detected by the difference detector to update the prediction model.

11. (canceled)

12. A method executed by a computer, the method being a method for creating a programmatic advertising delivery plan related to a target advertising campaign, the method comprising:
acquiring event planning information;
acquiring target condition information indicating a target condition; and
creating the delivery plan,
the event planning information being planning information on an external event in a future target period, the external event being an event of which implementation is plannable in advance, of which implementation or notification of the implementation affects results of programmatic advertising, and which is different from programmatic advertising delivery,
the target condition being a condition related to results of the programmatic advertising in the target period,
the creating the delivery plan comprising predicting the results of the programmatic advertising in the target period based on the event planning information, the programmatic advertising delivery plan in the target period, and a prescribed prediction model, and creating the programmatic advertising delivery plan in the target period so that the predicted results approach results indicated in the target condition information, and
the prediction model being a model for predicting the results of the programmatic advertising based on the event planning information and the programmatic advertising delivery plan.
